(19) United States
(12) Patent Application Publication
(10) Pub. No.: US 2019/0005551 A1
(43) Pub. Date: Jan. 3, 2019

(54) METHOD AND SYSTEM FOR CUSTOMIZED ELECTRONIC COMMUNICATIONS

(71) Applicant: Doron Aviad, Tel Aviv (IL)

(72) Inventor: Doron Aviad, Tel Aviv (IL)

(21) Appl. No.: 16/020,424

(22) Filed: Jun. 27, 2018

Related U.S. Application Data
(60) Provisional application No. 62/525,765, filed on Jun. 28, 2017.

(51) Int. Cl. G06Q 30/02; G06F 17/30

(52) U.S. Cl. CPC G06Q 30/0273; G06Q 50/01; G06F 17/30882; G06Q 30/0277

(57) ABSTRACT

Methods and systems provide for electronic message sending entities to receive compensation for providing content, such as information, including, advertisements, in electronic communications. The content is provided, for example, as activatable elements (links), that when activated, in a received electronic communication, result in the receiver's browsing application being directed to the web site associated with entity, e.g., content provider, such as an information provider or an advertiser, of the activatable element, and the activation is detected by the system so that the activation is accounted for and the sender is compensated for the display, activation and or conversion of the activatable element.

### CROSS-REFERENCES TO RELATED APPLICATIONS

This patent application is related to and claims priority from commonly owned U.S. Provisional Patent Application Ser. No. 62/525,765, entitled: Email Advertising, filed on Jun. 28, 2017, which the disclosure thereof is incorporated by reference herein in its entirety.

### TECHNICAL FIELD

The present invention relates to methods and systems for electronic communications, and information providing by the electronic communications.

### BACKGROUND

Electronic communications, typically in the form of email are a popular mode of communication. While backbone providers are able to add information, such as advertisements to email, only these backbone providers have profited from the advertising carried by these emails.

### SUMMARY OF THE INVENTION

The present invention includes embodiments that are directed to methods and systems for senders of electronic messages to profit from each electronic message that they send, by hosting activatable elements in their electronic messages, that when delivered, activated, or an event associated with the activation is complete, the message sender is entitled to compensation, typically monetary compensation. The activatable elements, typically include activatable graphics, such as impressions, or activatable links, such as hyperlinks, that when activated, direct the browsing application of the receiver to a destination over the world wide web (WWW) such as a web site on the Internet, corresponding to the entity of activatable element. The activatable elements are associated with information providers, including advertisers, who have placed bids with the system of the invention, for various keywords, identifiers, terms, concepts and the like. The system provides for each sending user to set up a profile for how their messages with these activatable elements are to look, rule and policies for to whom and at what times messages with activatable elements can be sent, the subject of the activatable elements which will be permitted in the electronic communications, and the compensation, and amount thereof, the sender will receive for sending the activatable elements in each electronic message. The sending user creates an electronic message, such as an electronic communication, typically an email.

The system of the invention is prompted that an electronic communication has been created, and in accordance with rues and policies of the sender, as provided by the sender to the system, or the system, selects, the subject for the activatable element and the information provider, associated with the subject. One or more activatable elements are provided to and placed in the body of the electronic communication, typically at the location in the electronic communication selected by the sender, and the electronic communication is sent, over a network, such as the Internet to intended recipient(s). In addition to the destination, e.g., web site, being linked to the activatable element, the activatable element is mapped (linked) to the system of the invention for recording, accounting, analytics, and administration purposes. The system of the invention is also linked, by the sender computer being mapped to it.

When the receiving user opens the electronic communication, and “clicks” or otherwise activates the activatable element in the body of the electronic communication, that user's browsing application is directed to the web site associated with the entity of the activatable element, and the “click” is received in the system, where it is recorded. In accordance with the agreement between the sender, and the system, the sender is compensated for the “click”, such as by pay per click, where the sender receives a certain amount for the receiving user having “clicked” on the activatable element.

Embodiments of the invention are directed to a method for creating electronic communications in which the sender receives compensation, for sending the electronic communication over a communications network. The method comprises: receiving selections of content by a computer system, for placement into electronic communications from a sender of an electronic communication; receiving, by the computer system, an indication of an amount associated with each electronic communication when an activatable element of the electronic communication is received by a recipient of the electronic communication; receiving an indication that an electronic communication is ready for sending to at least one intended recipient over the communications network; and, providing, by the computer system, data corresponding to at least one activatable element, the at least one activatable element corresponding to the selected content associated with at least one content provider, the at least one activatable element for placement into the electronic communication, the activatable element linked to a destination along the communications network associated with the at least one content provider and to at least one computer associated with the computer system along the communications network.

Optionally, the method is such that it additionally comprises: placing the at least one activatable element into the electronic communication.

Optionally, the method is such that it additionally comprises: transmitting the electronic communication including the activatable element to the at least one intended recipient.

Optionally, the method is such that it additionally comprises: receiving an indication that the at least one activatable element in a received electronic communication has been at least one of viewed, activated and/or converted, and, crediting the sender of the electronic communication with the agreed upon amount.

Optionally, the method is such that the crediting the sender includes paying the sender the agreed upon amount.

Optionally, the method is such that the electronic communication includes at least one of email short message service (SMS), texts, WhatsApp, messengers, and social media such as Facebook, MySpace, LinkedIn, and Instagram.

Optionally, the method is such that the activatable element includes at least one: an activatable graphic, an impression, and a hyperlink, that are linked to at least one target web page.

Optionally, the method is such that the content includes information and/or advertisements.

Embodiments of the invention are directed to a computer system for creating electronic communications, for sending over a communications network, such as the Internet, and providing a compensation amount to the sender of the electronic communications when an activatable element in the electronic communication is activated by a recipient of the electronic communication. The computer system comprises: a storage medium for storing computer components; and, a computerized processor for executing the computer components. The computer components comprise: at least one computer module configured for: receiving selections of content by a computer system, for placement into electronic communications from a sender of an electronic communication; receiving an indication of an amount associated with each electronic communication when an activatable element of the electronic communication is received by a recipient of the electronic communication; receiving an indication that an electronic communication is ready for sending to at least one intended recipient over the communications network; and, at least one computer module configured for providing data corresponding to at least one activatable element, the at least one activatable element corresponding to the selected content associated with at least one content provider, the at least one activatable element for placement into the electronic communication, the activatable element linked to a destination along the communications network associated with the at least one content provider and to at least one computer associated with the computer system along the communications network.

Optionally, the computer system is such that it additionally comprises: at last one computer module configured for placing the at least one activatable element into the electronic communication; and, at least one computer module for transmitting the electronic communication including the activatable element to the at least one intended recipient.

Optionally, the computer system is such that it additionally comprises: at least one computer module for receiving an indication that an activatable element in a received electronic communication has been activated, and crediting the sender of the electronic communication with the agreed upon amount.

Optionally, the computer system is such that it additionally comprises: at least one computer module for rendering the electronic communication as email.

Optionally, the computer system is such that it additionally comprises: at least one computer module for creating the activatable element as at least one of: an activatable graphic, an impression, a hyperlink.

Embodiments of the invention are directed to a computer usable non-transitory storage medium having a computer program embodied thereon for causing a suitable programmed system to create electronic communications for sending over a communications network, in which the sender receives compensation. The steps comprise: receiving selections of content for placement into electronic communications, from a sender of an electronic communication; receiving an indication of an amount associated with each electronic communication when an activatable element of the electronic communication is received by a recipient of the electronic communication; receiving an indication that an electronic communication is ready for sending to at least one intended recipient over the communications network; and, providing data corresponding to at least one activatable element corresponding to the selected content associated with at least one content provider, the at least one activatable element for placement into the electronic communication, the activatable element linked to a destination along the communications network associated with the at least one content provider and to at least one computer associated with the computer system along the communications network.

Optionally, the computer usable non-transitory storage medium additionally comprises performing the step of: placing the at least one activatable element into the electronic communication.

Optionally, the computer usable non-transitory storage medium additionally comprises performing the step of: transmitting the electronic communication including the activatable element to the at least one intended recipient.

Optionally, the computer usable non-transitory storage medium additionally comprises performing the step of: receiving an indication that an activatable element in a received electronic communication has been at least one of viewed, activated and/or converted, and crediting the sender of the electronic communication with the agreed upon amount.

Optionally, the computer usable non-transitory storage medium is such that the crediting the sender includes paying the sender the agreed upon amount.

Optionally, the computer usable non-transitory storage medium is such that the electronic communication includes at least one of email short message service (SMS), texts, WhatsApp, messengers, and social media such as Facebook, MySpace, LinkedIn, and Instagram.

Optionally, the computer usable non-transitory storage medium is such that the activatable element includes at least one: an activatable graphic, an impression, a hyperlink, for example, linked to a target web page, typically associated with the computer system selected content, that when the activatable element is activated, the browsing application associated with the recipient of the electronic communication is directed to the corresponding target web page.

This document references terms that are used consistently or interchangeably herein. These terms, including variations thereof, are as follows.

The terms “click”, “clicks”, “click on”, “clicks on”, “activates”, and “activation”, involves the activation of a computer pointing apparatus, such as a device commonly known as a mouse, or a “touch”, “swipe”, “contact”, or the like on a touch screen, on a location on a computer screen display, including screen displays of tablets and mobile computers, such as mobile telephones, e.g., smartphones. The screen displays are activatable, for example, by an activatable icon, that causes an action of the various software and or hardware, including that for executing applications and supporting the computer screen display.

Throughout this document, a “web site” is a related collection of World Wide Web (WWW) files that includes a beginning file or “web page” called a home page, and typically, additional files or “web pages.” The term “web site” is used collectively to include “web site” and “web page(s).”

A uniform resource locator (URL) is the unique address for a file, such as a web site or a web page, that is accessible over Networks including the Internet.

A “computer” includes machines, computers and computing or computer systems (for example, physically separate locations or devices), servers, computer and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., smartphone, personal digital assistant (PDA), mobile telephone or cellular telephone).

A server is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine, a software based emulation of a computer.

An “application”, includes executable software, and optionally, any graphical user interfaces (GUI), through which certain functionality may be implemented.

Pay Per Click (PPC) also called cost per click, is an internet advertising model used to direct traffic to websites, in which information providers, such as advertisers, pay the publisher (typically a website owner or a host of website) when the advertisement (ad) is clicked (clicked on), or otherwise activated.

Pay Per View is an internet advertising model when the ad is served and is viewable by the recipient.

Pay Per Conversion is an internet advertising model when the ad is clicked (clicked on), or otherwise activated and the recipient takes a further action, beyond this activation, such as purchasing a good or service from the target web page, enters information on the target we page, and the like.

A “client” is an application that runs on a computer, workstation or the like and relies on a server to perform some of its operations or functionality.

“n” and “nth” refer to the last member of a series, which may be constantly changing as members enter and leave the environment.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a diagram of an exemplary environment for the system in which embodiments of the disclosed subject matter are performed;

FIG. 2A is a diagram of the architecture of the main server of FIG. 1 and the system thereof;

FIGS. 2B-1 to 2B-5 are diagrams of databases from FIG. 2A;

FIG. 3 is a flow diagram for creating and sending messages in accordance with embodiments of the invention;

FIG. 4 is a flow diagram of processes in accordance with embodiments of the invention, once a message in accordance with the invention has been sent to and received by the recipient; and,

FIGS. 5 and 6 are screen diagrams of exemplary electronic communications in accordance with the invention;

FIGS. 7A, 7B-1 and 7B-2 are screen diagrams of exemplary electronic communications showing a bcc feature in accordance with the invention;

FIGS. 8A and 8B are screen diagrams of exemplary electronic communications showing a contextual feature in accordance with the invention; and,

FIGS. 9 and 10 are screen diagrams of example landing pages.

### DETAILED DESCRIPTION OF THE DRAWINGS

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more non-transitory computer readable (storage) medium(s) having computer readable program code embodied thereon.

Throughout this document, numerous textual and graphical references are made to trademarks, and domain names. These trademarks and domain names are the property of their respective owners, and are referenced only for explanation purposes herein.

The present invention provides methods and systems for electronic message sending entities to receive compensation for providing content, such as information, including, advertisements, in electronic communications. The electronic communications include, for example, email, short message service (SMS), texts, WhatsApp, messengers, social media such as Facebook, MySpace, LinkedIn, Instagram, and the like. The content is provided, for example, as activatable elements (links), that when activated, in a received electronic communication, result in the receiver's browsing application being directed to the web site associated with entity, e.g., content provider, such as an information provider or an advertiser, of the activatable element, and the activation is detected by the system so that the activation is accounted for and the sender is compensated for the display (view), activation and or conversion of the activatable element.

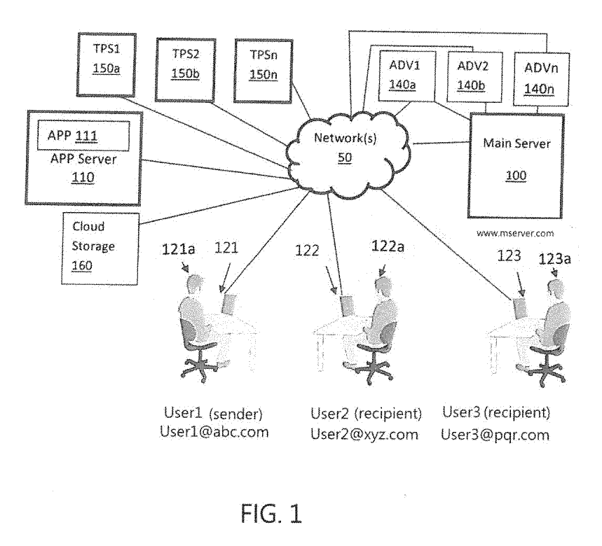

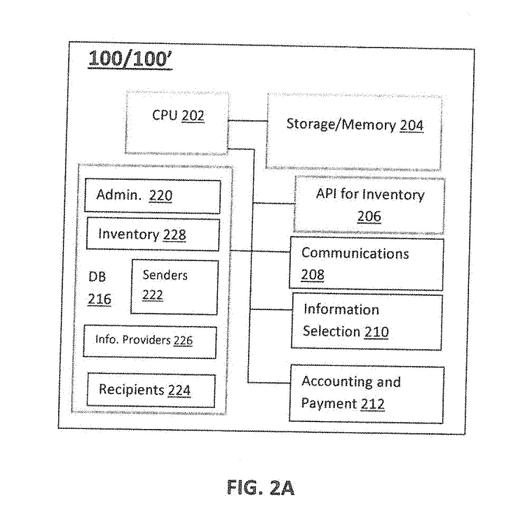

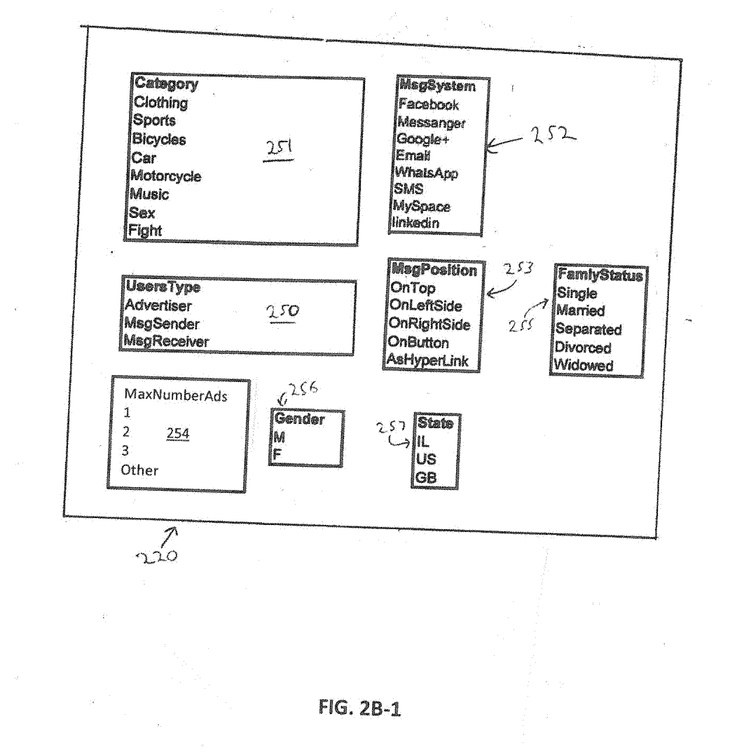

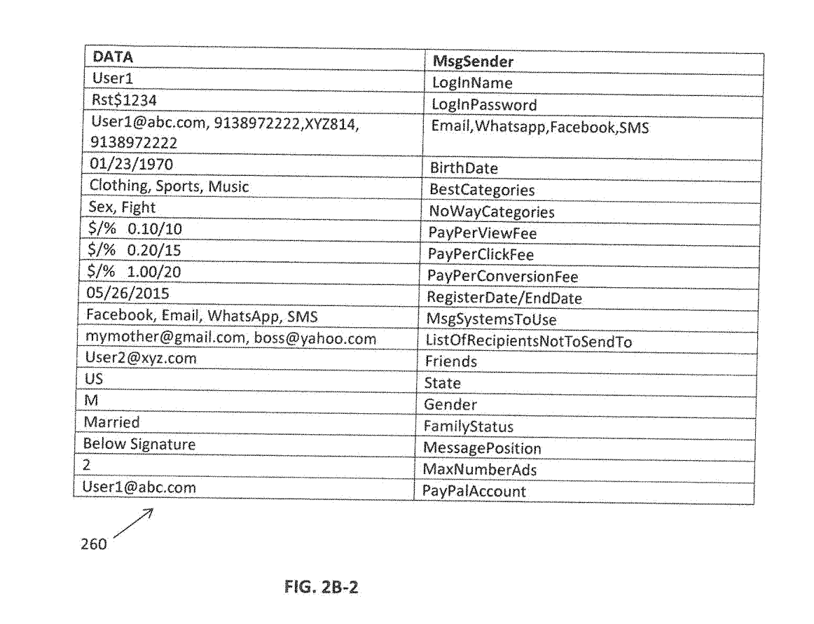

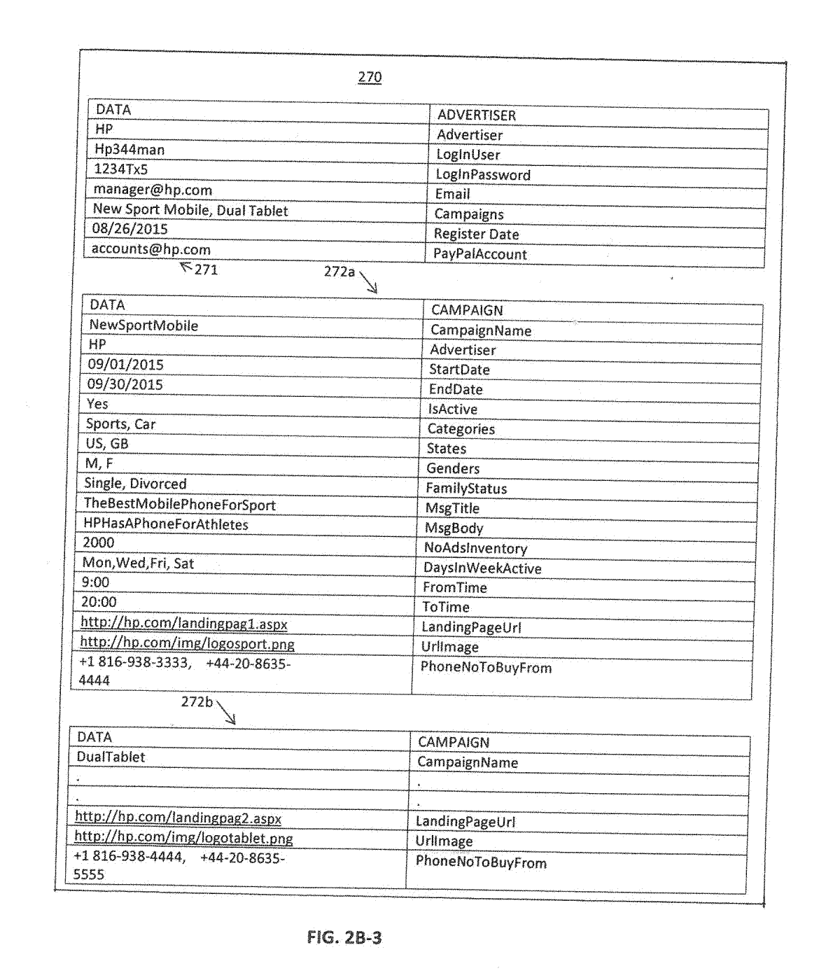

Reference is now made to FIG. 1, which shows an exemplary operating environment, including a network 50, to which is linked a main server (HS) 100. The main server 100 also defines a system 100′ (FIG. 2A), either alone or with other, computers, including servers, components, and applications, e.g., client applications, associated with either the home server 100, as detailed below. The network 50 is, for example, a communications network, such as a Local Area Network (LAN), or a Wide Area Network (WAN), including public networks such as the Internet. As shown in FIG. 1, as a single network, the network 50 may be a combination of networks and/or multiple networks including, for example, cellular networks. “Linked” as used herein includes both wired or wireless links, either direct or indirect, and placing the computers, including, servers, components and the like, in electronic and/or data communications with each other.

The various servers linked to the network 50, include, for example, an application (APP) server 110, which stores and makes accessible, for example, by downloading, the application (APP) 111 of the present invention. This application 111 may be obtained by entities, represented for example, by computers 121 such as that of User1 121a. The application 111 includes executable software, and graphical user interfaces (GUI), through which the messaging functionalities of the invention are implemented. The application (APP) 110 includes code segments which map to the system 100′ of the main server 100, for allowing user computer interaction with the system 100′, as well as mapping to the activatable links, web pages and the like, resulting from the placement thereof into electronic communications by the system 100′. This mapping by the APP 111 is such that links to web pages, and the web pages themselves, map to the computer of the sender and the main server, in order to track pay per views, pay per clicks and pay per conversions, so as to allow for accounting thereof and payment to electronic communication senders.

User computers 122, 123 of recipients 122a, 123a, are also linked to the network. User2 122a and User3 123a represent recipients of electronic communications from the sender User1 121a, as discussed in greater detail below.

There are also additional servers 140a-140n, 150a-150n and 160, are linked to the network 50. Servers 140a-140n are those of information providers, such as advertisers (adv) (ADV1 to ADVn). Servers 150a-150n are those which host of target web sites, such as those associated with the content providers, including information providers, such as advertisers ADV1 to ADVn. Server 160 represents a server which performs storage of data in the “cloud.”

The main server (MS) 100 is of an architecture that includes one or more components, engines, modules and the like, for providing numerous additional server functions and operations, and, for running the processes of the system 100′ of the invention (if the main server 100 is accessed directly, or associated with the application 111, which maps to the main server 100, upon its being downloaded or otherwise obtained and installed, for example on each user computer, such as user computer 121. The main server (MS) 100 may be associated with additional storage, memory, caches and databases, both internal and external thereto. For explanation purposes, the main server (MS) 100 may have a uniform resource locator (URL) of, for example, www.mserver.com. While a single main server (MS) 100 is shown, the main server (MS) 100 may be formed of multiple servers and/or components.

Attention is now directed to FIG. 2A, which shows the architecture of the system 100′, for example, in the main server 100. This architecture of the system 100′, as shown, for example, in the main server 100, includes a central processing unit (CPU) 202 formed of one or more processors, electronically connected, including in electronic and/or data communication with storage/memory 204, API module 206, communications module 208, information (e.g., information providing or advertising campaign, or information providing or advertising content) selection module 210, accounting and payment module 212 and database(s) (DB) 216.

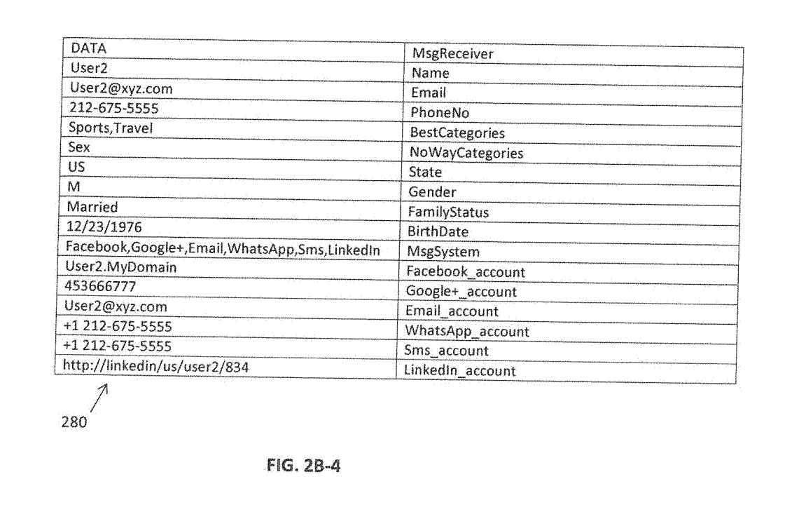

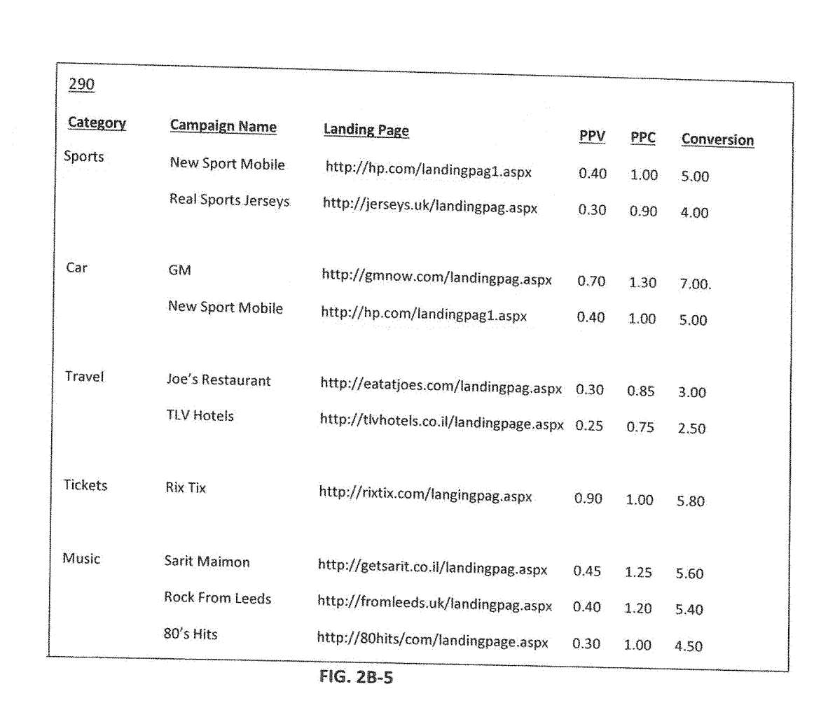

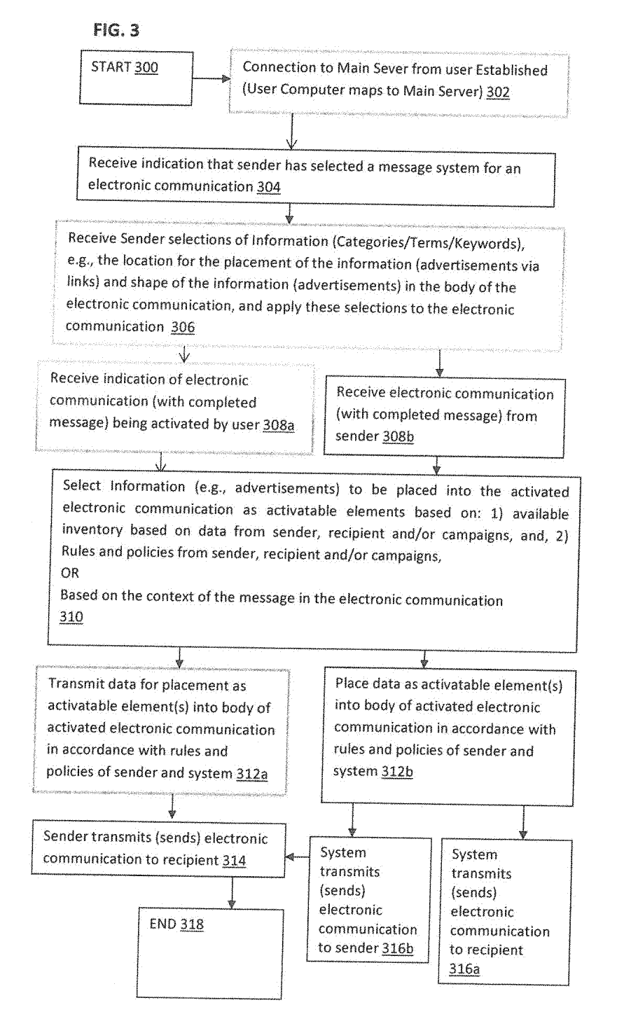

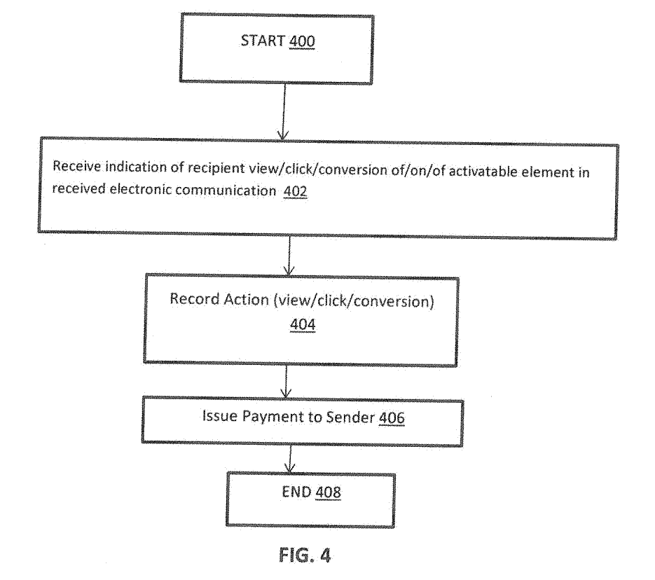

The Central Processing Unit (CPU) 202 is formed of one or more processors, including microprocessors, for performing the home server 100 and system 100′ functions and operations detailed herein, including controlling the storage media 204, API 206, communications module 208, Information Selection module 210, and Accounting and payment module 212, and databases 216, along with the processes and subprocesses shown in FIGS. 3 and 4, as detailed below. The processors are, for example, conventional processors, such as those used in servers, computers, and other computerized devices. For example, the processors may include x86 Processors from AMD and Intel, Xenon® and Pentium® processors from Intel, as well as any combinations thereof.

The storage/memory 204 is any conventional storage media. The storage/memory 204 stores machine executable instructions for execution by the CPU 202, to perform the processes of the invention. The storage/memory 204 also includes machine executable instructions associated with the operation of the components, including the API 206, communications module 208, Information Selection module 210, Accounting and Payment module 212, databases 216, and applications 111, and all instructions for executing the processes of FIGS. 3 and 4, detailed herein. The storage/memory 204 also, for example, stores rules and policies for the system 100′ and the home server 100. The processors of the CPU 202 and the storage/memory 204, although shown as a single component for representative purposes, may be multiple components, and may be outside of the home server 100 and/or the system 100′, and linked to the network 50.

The Application Programming Interface (API) module 206 functions to specify how the system 100′ requests, retrieves, and may share data from servers and other computers and the like outside of the system 100′, including those linked to the network 50. The API module 206 also functions to facilitate the interaction of the various software, components, modules, and databases with each other, and also interactions with other servers and the like outside of the system 100′, for operation of the disclosed processes.

The communications module 208 is designed to handle communications over networks 50, such as the Internet, cellular networks and the like.

The information selection module 210 runs various programs for determining the information (e.g., advertising) campaign to select as the content for placement into the sender's electronic communication(s). The content includes, for example, information, including advertising and advertisements, which appear, for example, graphically as impressions and other graphics, hyperlinks (linked to target web pages, associated with the information provider or advertiser), to which a browser (of the electronic communication recipient) is redirected when the hyperlink is activated (by the electronic communication recipient), and the like. The graphics cover activatable links in the body of the received electronic communication. The activatable links are linked to target web pages, associated with the information provider or advertiser, to which a browser (of the electronic communication recipient) is redirected when the activatable link (the graphic) is activated (by the electronic communication recipient), and the like.

The determination of the content to select, by the information selection module 210 is based on one or more of sender data, including sender parameters, and/or, rules and policies, information provider (e.g., advertiser) data, including information provider (e.g., advertiser) parameters, and/or rules and policies, recipient data, including recipient parameters and/or rules and policies and any combination thereof. The selection module also arbitrates between various data, including parameters and rules and policies of the sender, information provider or recipient. This module 210 also determined whether to override selections based on data from the sender, information provider, and/or recipient(s) and instead, go to contextual information provider (e.g., advertiser) based on analyzing the context of the message being sent in the electronic communication by the sender.

The accounting and payment module 212 monitors all financial transactions from pay per views, pay per clicks and pay per conversions, and handles payments to the various senders of the electronic communications as well as the system 100′. Payments are, for example, based on revenue shares that the senders of electronic communications of the system 100′ (registered in the system 100′) have with the system 100′. These revenue shares are for pay per view, pay per click and pay for conversion, for example, as determined by the senders, and are, for example, contractual with the system 100′ (system administrator or system administrator entity).

The databases (DB) 216 include numerous databases in one or more storage media. Exemplary databases include those for administration 220, message senders 222, recipients 224 of messages from the system 100′, information providers/advertisers and their campaigns 226, and inventory 228, held by the system 100′.

An example of the data, which make up the various databases 220, 222, 224, 226, and 228 is shown in FIGS. 2B-1 to 2B-5.

The Administration Database 220 of FIGS. 2B-1 provides a menu (UsersType) 250 for selections of the type of user 250. Should the user type be a message sender (MsgSender), menus 251-257 are applicable. The senders (MsgSender) on the system 100′, select from a menu 251 for various categories that a sender can select from which to obtain inventory for sending. Menu 252 allows the sender to select the type of messaging system (MsgSystem) he prefers to use. Menu 253 allows the sender to select the position of the information in the message body (MsgPosition), that will be sent to the intended recipient, as well as if the activatable link will be in the form of a hyperlink (for example, if this option is selected, the information selection module 210 will select based on context of the message being sent). Menu 254 allows the sender to select the maximum number of information spots, e.g., advertisements, as, activatable links, to be sent in each message. Menu 255 allows the sender to select his family status, while menu 256 is for a gender selection, and menu 257 is for a geographic location (country/state) selection.

Similarly, should the user be an information provider, e.g., an advertiser, as per the UsersType of block 250, selections are be made, for example, from menus 251, 252, 255, 256, 257. The advertiser may run one or more campaigns, with each campaign having different settings, data, rules and policies and the like.

Similarly, should the user be a message receiver, the sender, who lists the message receiver as a “friend” in his database entry, for example, database entry 260 of FIG. 2B-2, or the receiver himself, would be the MsgReceiver of block 250. Selections for this message receiver (MsgReceiver) are, for example, made from menus 251, 252, 255, 256 and 257.

FIG. 2B-2 is a data listing 260 for a sender, for example, user1 121a, from the Senders database 220. Each sender would have such a data listing 260 in this database 220. For example, user1 121a prefers to send information, such as advertisements in categories or campaigns for clothing, sports and music, but does not want anyone receiving information from him in his messages, concerning categories or campaigns for subject matter associated with sex or fighting. User1 121a also does not want any information accompanying his communications to mymother@gmail.com, or boss@yahoo.com. The user, e.g., sender, may also provide data as phone numbers, social media identifiers, and the like, so that the individuals and groups associated therewith receive only the electronic communication with the message in the body thereof, free of any information, advertising and the like. User1 121a wants his messages in the communication below the signature, and only wants one information spot/advertisement per communication. Also, the time period as well as the specific times when the messages are to include information/spots advertisements is also provided, as well as other details as to conditions for the messages.

FIG. 2B-3 is a data listing for an advertiser, for example, HP, for their “New Sport Mobile” Campaign, in the Info. Provider/Advertiser database 226. There is a listing of data 270 on the actual advertiser 271, as well as listings 272a, 272b, for each campaign for this advertiser, e.g., “New Sport Mobile”, and “Dual Mode Tablet”.

FIG. 2B-4 is a data listing for a message recipient, for example User2, in the Recipients database 224. There is a listing of data 280 for this recipient.

FIG. 2B-5 shows a listing 290 of active inventory in the inventory in the system. The inventory includes a list of various content providers, such as information providers, including advertisers, listed by a keyword or category for a campaign. For example, campaigns are shown for keywords or categories, such as sports, cars, travel, tickets and music.

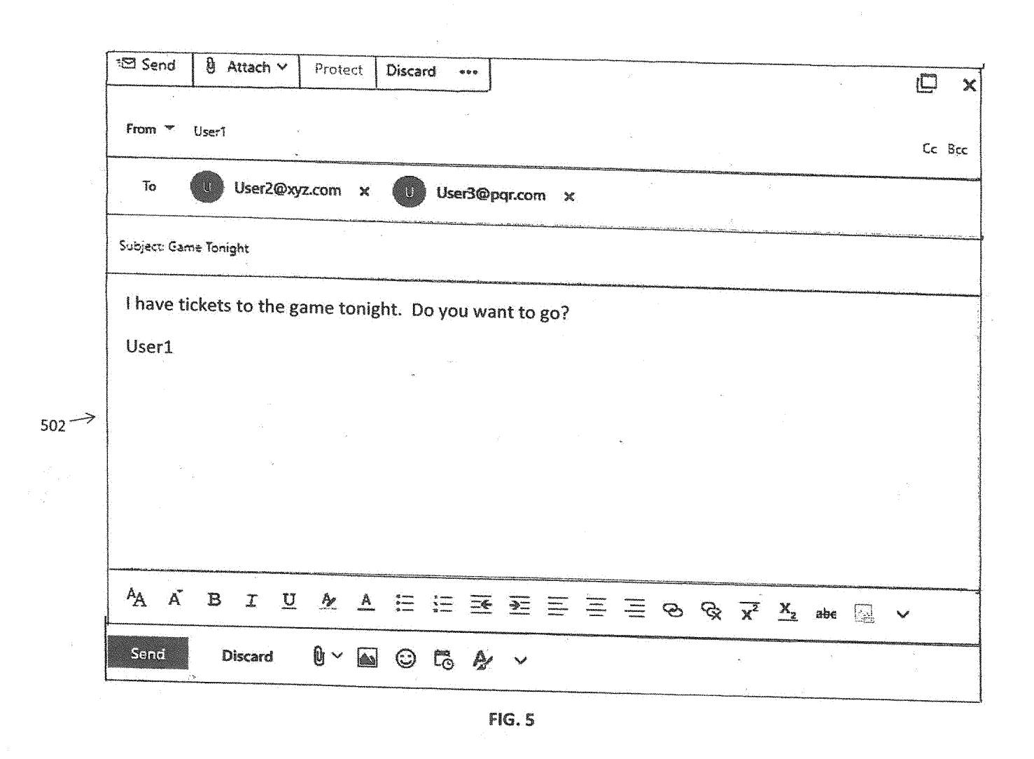

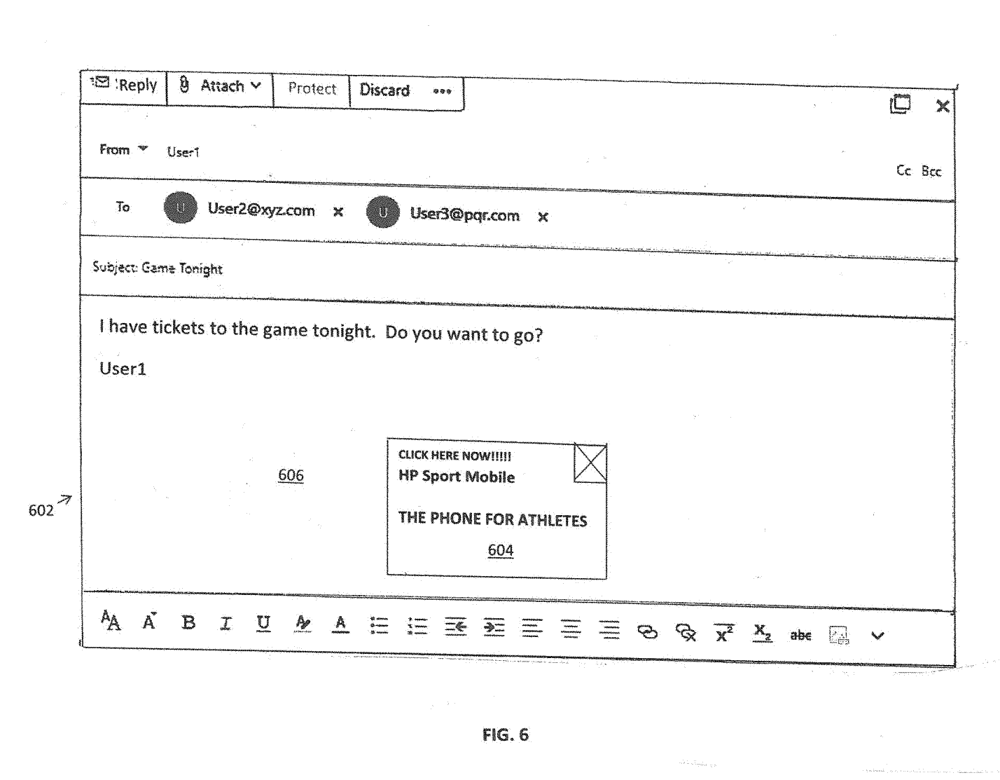

Attention is now directed to FIGS. 3 and 4, which show flow diagrams detailing computer-implemented processes in accordance with embodiments of the disclosed subject matter. Reference is also made to elements shown in FIGS. 1, 2A, and, 2B-1 to 2B-5. The process and subprocesses of FIGS. 3 and 4 are computerized processes performed by the system 100′ in conjunction with the application 111, deployed on the computer 121 of the user 121a, e.g., user1@abc.com, who is the sender of the message (electronic communication). The aforementioned processes and sub-processes can be, for example, performed manually, automatically, or a combination thereof, and, for example, in real time. Reference is also made to the diagrams and screen shots of FIGS. 5 and 6, which appear on the monitor, e.g., touchscreen, of the computer, e.g., smartphone, of the sending user computer 121, and receiving users (receivers), e.g., User2 122a (user2@abc.com), and User3 123a (user3@xyz.com).

In FIG. 3, an embodiment of a process is shown in the sequence of even-numbered blocks. An alternative process, where sending is from the system 100′ is shown by the sequence of even and odd numbered blocks.

Prior to the START block 300 of the process detailed in FIG. 3, a sender, for example, User1, 121a via his computer 121, with the APP 111 installed and running thereon.

From the START block 300, the process moves to block 302. At block 302, a connection between the main server 100 and the sender computer 121 is established, for example, via the APP 111 (which maps the sender computer 121 to the main server 100 and the system 100′). The sender computer 121 interacts with the main server 100, and for the disclosed process of FIG. 3, maps to the main server 100.

The process moves to block 304, where the system 100′ (of the main server 100) receives an indication that an electronic communication to one or more recipients, for example, user2 122a and user3 123a, by messaging systems (MsgSystem of FIG. 2B-1), for example, email, Messenger, WhatsApp, SMS, and social networks, such as Facebook, Instagram, LinkedIn, MySpace, Google+, and the like, has been selected for a message. The selected electronic communication will include the message, e.g., message text, graphics, attachments, and the like.

The process moves to block 306, where the sender selections of Information (Categories/Terms/Keywords) for the desired ads to be placed into the electronic communication, as well as, for example, the location for the information (ad) and shape of the information (ad) in body of the electronic communication, as shown for example, in data table 260 of FIG. 2B-2, are applied to the electronic communication.

From block 306, the process moves to blocks 308a and 308b, which are alternatives for processing the electronic communication (e.g., with the completed message), and now ready to be sent to the recipient(s). At block 308a, the system 100′ receives an indication of an electronic communication being activated by the sender 121a, for example, via the aforementioned mapping (via the APP 111). For example, the activated communication may be that shown in FIG. 5, an electronic mail (email) message 502, from the sender, e.g., User1 (sender) 121a to two recipients, User2 122a and User3 123a. Alternately, at block 308a, the system 100′ receives the electronic communication, for example, the electronic communication 502 of FIG. 5, as sent from the computer 121 of the sender, user1 121a (to recipients user2@xyz.com and user3@pqr.com), to the system 100′ (of the main server 100) over the network(s) 50.

From blocks 308a and 308b, the process moves to block 310. At block 310, the system 100′, for example, the information selection module 210, selects the content, such as information including advertisement(s), and places the content as activatable links (e.g., graphics, such as impressions, hyperlinks and the like) into the electronic communication (for example, into the body of the electronic communication, typically near the message). The advertisement(s) are typically selected from the inventory 228 (FIG. 2A) but may be from an outside provider if a suitable advertisement is not found in the inventory. Typically, the system 100′, via the information selection module 210 select Information, e.g. advertisements, to be placed into the activated electronic communication as activatable elements based on: 1) available inventory based on data from sender, recipient and/or campaigns, and, 2) Rules and policies from the sender, the recipient and/or the campaigns. These rules and policies include, for example, times electronic communications with the activatable elements can be sent, to whom such electronic communications with activatable elements can and cannot be sent, the categories or subject matter of the activatable elements that can and cannot be sent, the percentages or amounts of a revenue share between the sender and the system 100′, the number of activatable elements that may be in an electronic communication, and the time period which the sender 121a will allow activatable elements in his electronic communications. For example, these rules and policies are shown, for example, in the list 260 of the sender database 222 of FIG. 2B-2, the campaigns 272a, 272b of FIG. 2B-3, the recipient database entry 280 of FIG. 2B-4. The selection module 210 is also configured to arbitrate and select an advertisement from the inventory 228, if necessary. Also, the selection module 210 can analyze the context of the message in the electronic communication to select the information, e.g., advertisements, for the electronic communications.

From block 310, depending on the previous processing of the electronic communication, the process moves to either blocks 312a or 312b. At block 312a, the selected information, e.g., advertisements, which present as activatable links covered by an activatable graphic, are sent to the electronic communication of the user computer 121 by the selection module 210, for placement into the body of the electronic communication, in accordance with the sender data (preferences) for the arrangement of the body of the electronic communication, as detailed above. At block 312b, the selected information, e.g., advertisements, which present as activatable links covered by an activatable graphic, are sent to the electronic communication in the system 100′(by the selection module 210), for placement into the body of the electronic communication, in accordance with the sender data (preferences) for the arrangement of the body of the electronic communication, as detailed above.

From block 312a, the process moves to block 314, where the sender sends the now loaded electronic communication to the recipient(s). This iteration of the process ends at block 318.

Returning to block 312b, the process moves to blocks 316a or 316b. If the process moves to block 316a, the loaded electronic communication is sent by the system 100′, via the communications module 208, to the intended recipient, e.g., user2 122a (computer 122) and user3 123a (computer 123), for example, over the network 50. This iteration of the process ends at block 318.

Alternately, if the process moves to block 316b, where the loaded electronic communication is sent by the system 100′, via the communications module 208, to the sender computer 121. The process then moves to block 314, where the sender transmits the loaded electronic communication to intended recipient, e.g., user2 122a (computer 122) and user3 123a (computer 123), for example, over the network 50. This iteration of the process ends at block 318.

For example, at block 318, the electronic communication 502 of FIG. 5 has been modified by the system 100′, to produce the electronic communication 602 of FIG. 6.

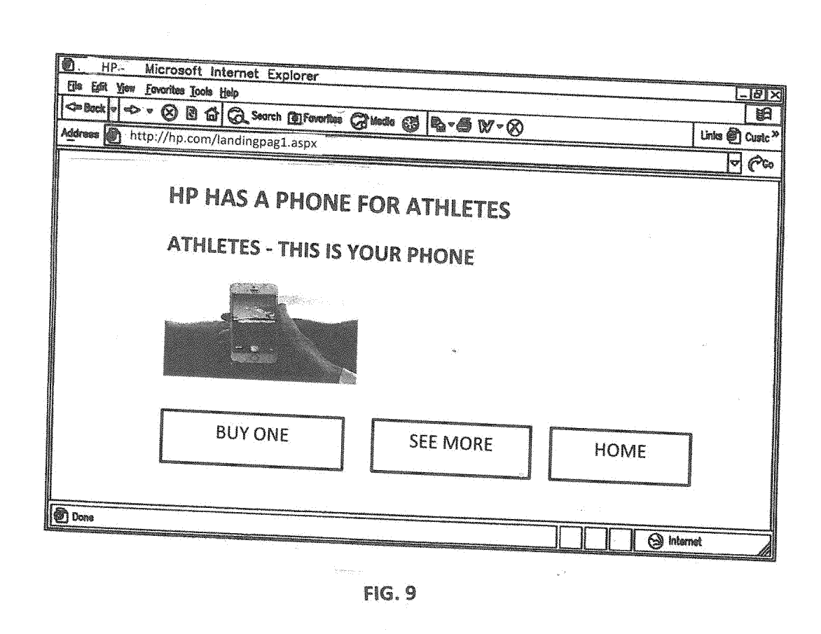

This electronic communication 602, includes, for example, an activatable element 604, shown graphically as advertising content (e.g., HP Sport Mobile), in the body 606 of the electronic communication 602. The activatable element 604 is linked to a target web page, such as that shown in FIG. 9 (landing page with the address http://hp.com/landingpag1.aspx), when the activatable element (link) 604 is activated, by a mouse click, swipe, contact, or the like. For example, as per FIG. 6, the information selection module 210 selected the advertising campaign “New Sport Mobile” with the advertising content (and activatable link) 604 as both the sender, user1, and recipient user2, in their respective database entries 260 (sender, user1) and 280 (recipient, user2) have “Sports” in common in their “Best Categories” entry.

The process now resumes as a process detailed by the flow diagram of FIG. 4, to which attention is also directed. From the START block 400, where the electronic communication has been received and, for example, is displayed on the monitor or screen of the recipient's computer. This received electronic communication is, for example, shown in FIG. 6, which has been described above.

The process moves to block 402. At block 402, the system 100′ receives an indication of a view, “click” or other activation of the activatable element 604, or conversion, originating with activation of the activatable element.

The action, the view, click or conversion, is recoded by the system 100′, e.g., the accounting and payment module 212, at block 404. Also at block 404, based on the revenue share, between the system 100′ and the sender, e.g., user1 121a, the revenue share amount is determined and credited for payment to the sender. At block 406, the system 100′, via the accounting and payment module 212, issues the payment to the sender, For example, the sender, e.g., user1 122a, may be paid through his pay pal account, which is listed in his data 260. The process moves to block 408, where it ends.

Referencing FIG. 6 and returning to block turning to block 404, assuming the sender has decided he wants to be paid based on pay per click (PPC). Also assume that at block 402, the activation was a click on the activatable element 604 of the email 602, and the recipient, e.g., user2, is now viewing the landing page (FIG. 9), which is the target web page of the activatable link 604. The recipient's (user2) click on the activatable link 604 is recorded by the system 100′, e.g., the accounting and payment module 212. Here, as shown in FIG. 2B-5, for the category “Sports” and the system selected campaign “New Sport Mobile”, the PPC is $1.00. Referring back to the database entry 260 for the sender, user1, a revenue share for a PPC (PayPerClickFee) is $0.20 of the $1.00, or fifteen percent of the $1.00 or $0.15, as the revenue share. Assuming there is a rule or policy for the sender to get the greater of the fixed amount or the percentage amount, the sender, e.g., user1, will be credited and paid his revenue share of $0.20, for this activation (e.g., click, swipe, contact, or other activation, by the recipient, e.g., User2.

The processes of applying the revenue share and payment thereof to the sender for recipient views (PPV and PayPerViewFee) and conversions (PayPerConversionFee), would be performed similarly to the process described above for pay per click (PPC and PayPerClickFee).

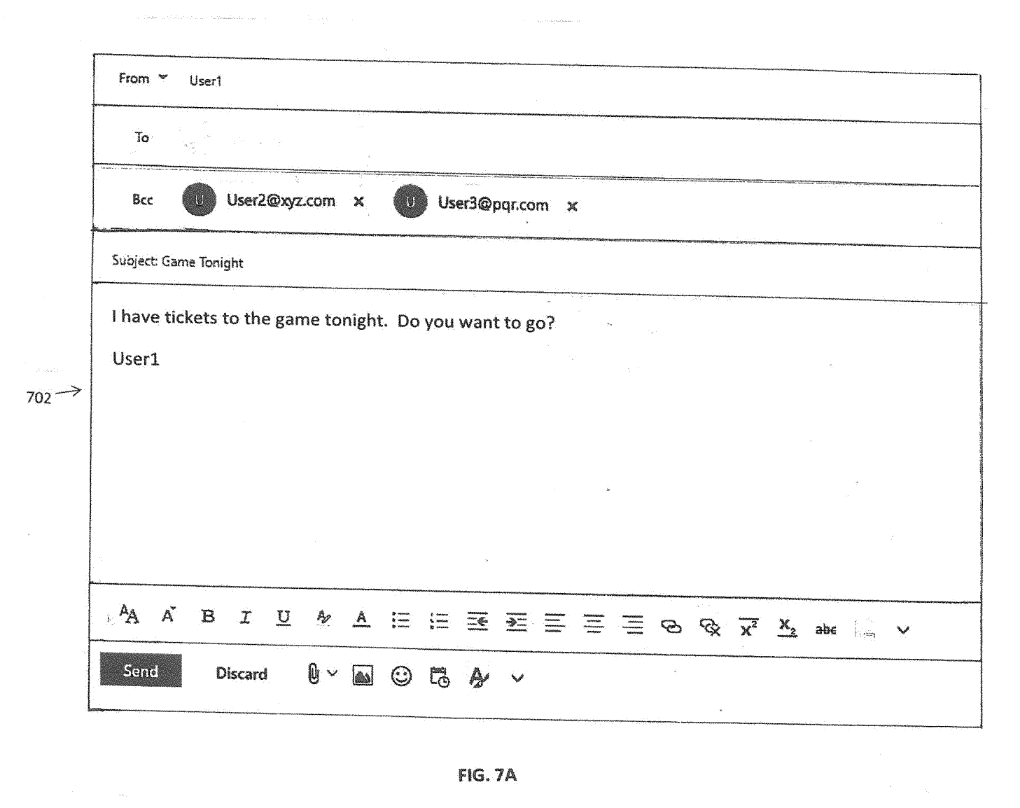

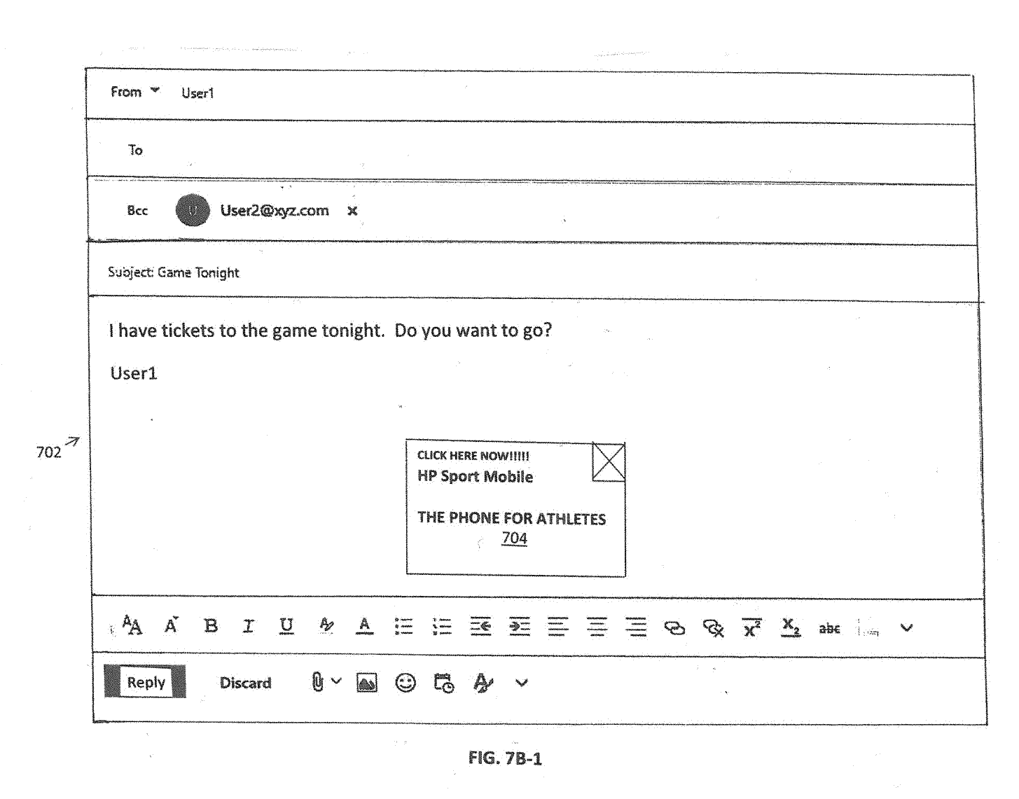

Attention is now directed to FIGS. 7A, 7B-1 and 7B-2. In FIG. 7A, the sender, User1 is sending an electronic communication, e.g., an email 702, to recipients user2 (user2@xyz.com) and user3 (user3@pqr.com) using a bcc feature of the system 100′. This bcc feature is a system 100′ process where different recipients receive different content, e.g., information or advertisements, as selected by the information selection module 210, and corresponding activatable links in the body of the electronic communication.

Accordingly, for user2, the system 100′, via the information selection module 210, has selected the “New Sport Mobile” campaign from the “Sports” category, as both the sender, user1, and recipient user2, in their respective database entries 260 (sender, user1) and 280 (recipient, user2) have “Sports” in common in their “Best Categories” entry. Accordingly, as shown in FIG. 7B-1, the electronic communication (e.g., email) 702 received by the recipient, e.g., user2, includes the activatable link 704, when activated, causes a browser redirect to the landing page of FIG. 9, with the address http://hp.com/landingpag1.aspx. The revenue shares for the sender, User1, are as listed in the database entry 260, and are calculated as detailed for the process of FIG. 4, as detailed above.

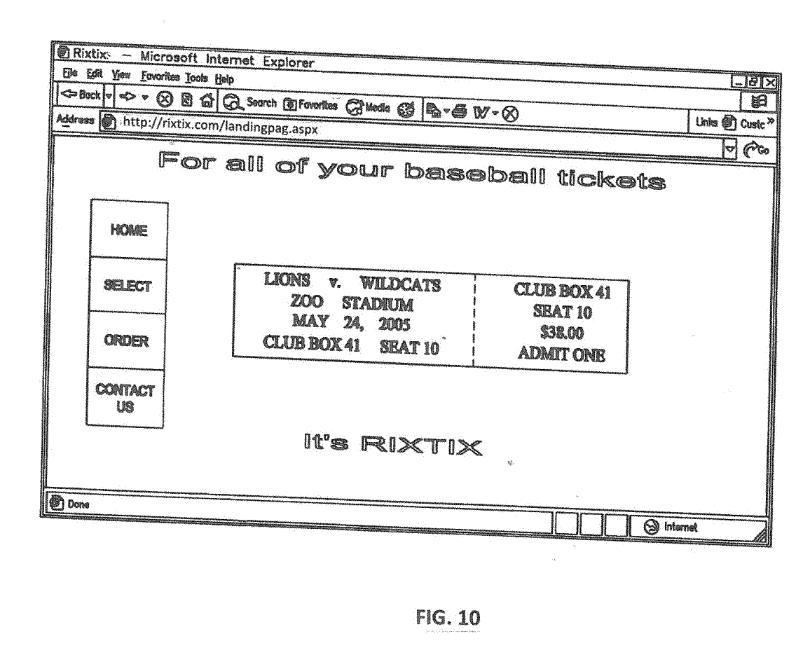

For user3, the system 100′, via the information selection module 210, has selected the “Rix Tix” campaign from the “Tickets” category and the “Joe's Restaurant” from the “Travel” category, as the recipient user3, has not provided, and the sender has not provided, any data on user3. Accordingly, as shown in FIG. 7B-2, the electronic communication (e.g., email) 702 received by the recipient, e.g., user3, includes the activatable links 706, 708. For example, when link 706 is activated, the browser of the computer 123 of user3 123a redirects to the landing page of FIG. 10, with the address http://rixtix.com/landingpag.aspx. The revenue shares for the sender, User1, are as listed in the database entry 260, and are calculated as detailed for the process of FIG. 4, as detailed above.

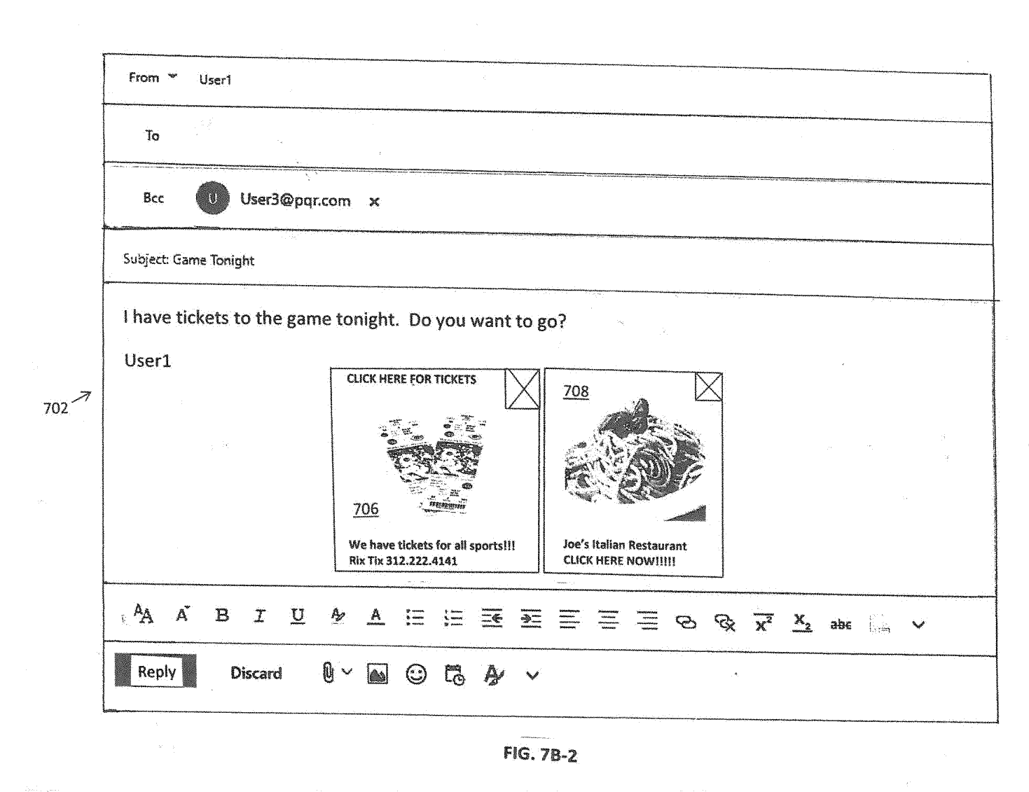

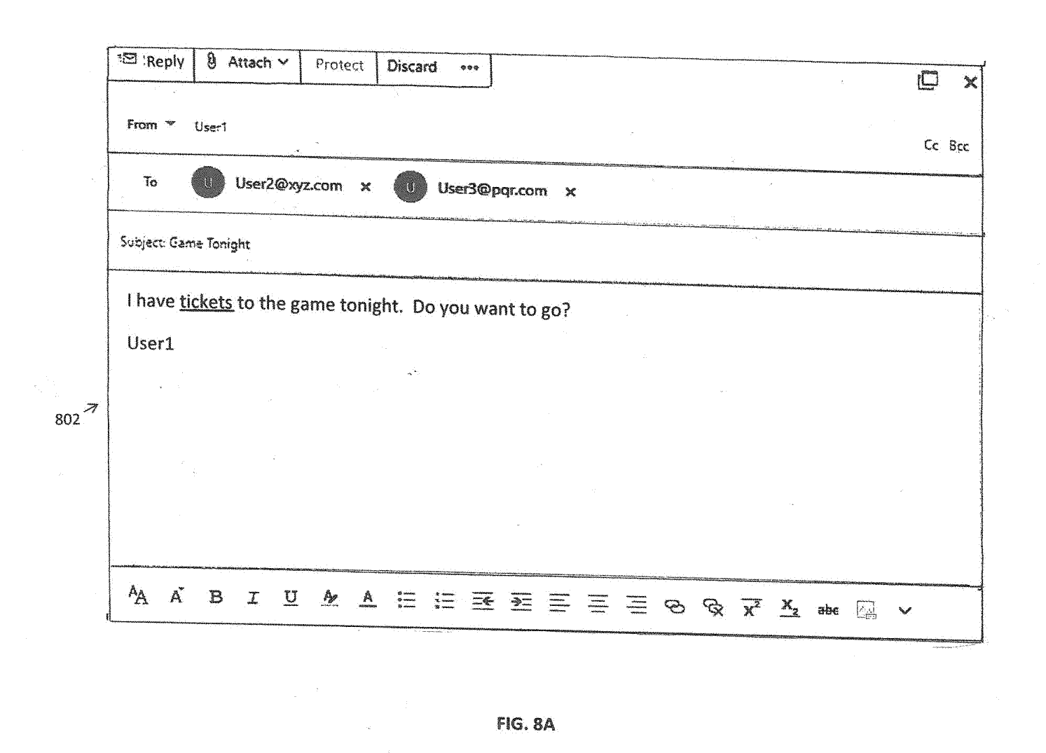

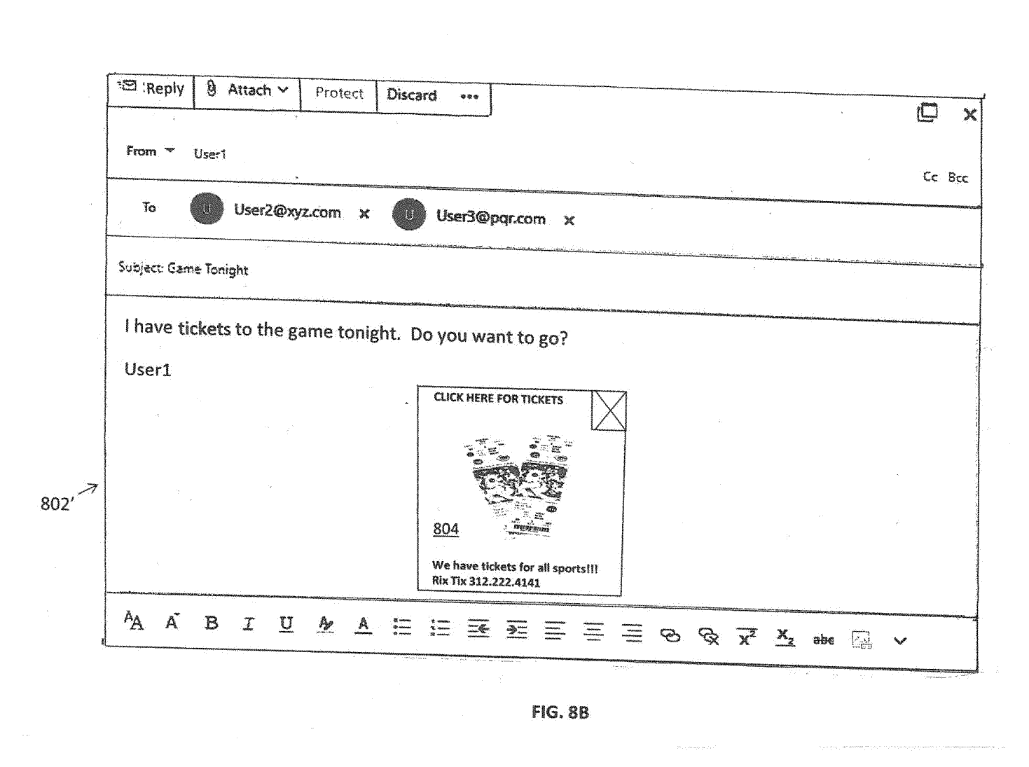

Attention is now directed to FIGS. 5, 8A, and 8B, to illustrate the selection of the content based on the context of the message in the electronic communication. In FIG. 5, the sender, User1 is sending an electronic communication, e.g., an email 502, to recipients user2 and user3. The message in the body of the email 502 is, “I have tickets to the game tonight. Do you want to go? User1”. The information selection module 210, detects the keyword/term “tickets” and selects the campaign “Rix Tix” form a corresponding category “Tickets” in the database entry 290 (FIG. 2B-5) for the inventory (database) 228 (FIG. 2A). The resultant electronic communications, as prepared by the system 100′ as detailed in FIG. 3, above, are emails 802 of FIG. 8A, and 802′ of FIG. 8B.

The email 802 of FIG. 8A has made, the word “tickets” a hyperlink (as “tickets”) is shown underlined. When this hyperlink, e.g., “tickets”, is clicked on, or otherwise activated, the browser of the computer of the recipient user (e.g., user2 and/or user3, depending on their individual activations of the hyperlink) redirects to the landing page of FIG. 10, with the address http://rixtix.com/landingpag.aspx. The revenue shares for the sender, User1, are as listed in the database entry 260, and are calculated as detailed for the process of FIG. 4, as detailed above.

The email 802′ of FIG. 8B provides graphic content, as an activatable link 804 to the target web page for Rix Tix. When this activatable link 804 is clicked on, or otherwise activated, the browser of the computer of the recipient user (e.g., user2 and/or user3, depending on their individual activations of the hyperlink) redirects to the landing page of FIG. 10, with the address http://rixtix.com/landingpag.aspx. The revenue shares for the sender, User1, are as listed in the database entry 260, and are calculated as detailed for the process of FIG. 4, as detailed above.

The implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, microprocessors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method for creating electronic communications in which the sender receives compensation, for sending the electronic communication over a communications network, comprising:
receiving selections of content by a computer system, for placement into electronic communications from a sender of an electronic communication;
receiving, by the computer system, an indication of an amount associated with each electronic communication when an activatable element of the electronic communication is received by a recipient of the electronic communication;
receiving an indication that an electronic communication is ready for sending to at least one intended recipient over the communications network; and,
providing, by the computer system, data corresponding to at least one activatable element, the at least one activatable element corresponding to the selected content associated with at least one content provider, the at least one activatable element for placement into the electronic communication, the activatable element linked to a destination along the communications network associated with the at least one content provider and to at least one computer associated with the computer system along the communications network.

2. The method of claim 1, additionally comprising: placing the at least one activatable element into the electronic communication.

3. The method of claim 2, additionally comprising: transmitting the electronic communication including the activatable element to the at least one intended recipient.

4. The method of claim 3, additionally comprising: receiving an indication that the at least one activatable element in a received electronic communication has been at least one of viewed, activated and/or converted, and, crediting the sender of the electronic communication with the agreed upon amount.

5. The method of claim 4, wherein the crediting the sender includes paying the sender the agreed upon amount.

6. The method of claim 4, wherein the electronic communication includes at least one of email short message service (SMS), texts, WhatsApp, messengers, and social media such as Facebook, MySpace, LinkedIn, and Instagram.

7. The method of claim 4, wherein the activatable element includes at least one: an activatable graphic, an impression, and a hyperlink, that are linked to at least one target web page.

8. The method of claim 1, wherein the content includes information and/or advertisements.

9. A computer system for creating electronic communications, for sending over a communications network, and providing a compensation amount to the sender of the electronic communications when an activatable element in the electronic communication is activated by a recipient of the electronic communication, comprising:
a storage medium for storing computer components;
a computerized processor for executing the computer components comprising:
at least one computer module configured for:
receiving selections of content by a computer system, for placement into electronic communications from a sender of an electronic communication;
receiving an indication of an amount associated with each electronic communication when an activatable element of the electronic communication is received by a recipient of the electronic communication;
receiving an indication that an electronic communication is ready for sending to at least one intended recipient over the communications network; and,
at least one computer module configured for providing data corresponding to at least one activatable element, the at least one activatable element corresponding to the selected content associated with at least one content provider, the at least one activatable element for placement into the electronic communication, the activatable element linked to a destination along the communications network associated with the at least one content provider and to at least one computer associated with the computer system along the communications network.

10. The computer system of claim 9, additionally comprising:
at last one computer module configured for placing the at least one activatable element into the electronic communication; and,
at least one computer module for transmitting the electronic communication including the activatable element to the at least one intended recipient.

11. The computer system of claim 10, additionally comprising at least one computer module for receiving an indication that an activatable element in a received electronic communication has been activated, and crediting the sender of the electronic communication with the agreed upon amount.

12. The computer system of claim 11, additionally comprising at least one computer module for rendering the electronic communication as email.

13. The computer system of claim 11, additionally comprising at least one computer module for creating the activatable element as at least one of: an activatable graphic, an impression, a hyperlink.

14. A computer usable non-transitory storage medium having a computer program embodied thereon for causing a suitable programmed system to create electronic communications for sending over a communications network, in which the sender receives compensation, the steps comprising:
receiving selections of content for placement into electronic communications, from a sender of an electronic communication;
receiving an indication of an amount associated with each electronic communication when an activatable element of the electronic communication is received by a recipient of the electronic communication;
receiving an indication that an electronic communication is ready for sending to at least one intended recipient over the communications network; and,
providing data corresponding to at least one activatable element corresponding to the selected content associated with at least one content provider, the at least one activatable element for placement into the electronic communication, the activatable element linked to a destination along the communications network associated with the at least one content provider and to at least one computer associated with the computer system along the communications network.

15. The computer usable non-transitory storage medium of claim 14, additionally comprising the step of: placing the at least one activatable element into the electronic communication.

16. The computer usable non-transitory storage medium of claim 15, additionally comprising the step of: transmitting the electronic communication including the activatable element to the at least one intended recipient.

17. The computer usable non-transitory storage medium of claim 16, additionally comprising the step of: receiving an indication that an activatable element in a received electronic communication has been at least one of viewed, activated and/or converted, and crediting the sender of the electronic communication with the agreed upon amount.

18. The computer usable non-transitory storage medium of claim 17, wherein crediting the sender includes paying the sender the agreed upon amount.

19. The computer usable non-transitory storage medium of claim 17, wherein the electronic communication includes at least one of email short message service (SMS), texts, WhatsApp, messengers, and social media such as Facebook, MySpace, LinkedIn, and Instagram.

20. The computer usable non-transitory storage medium of claim 17, wherein the activatable element includes at least one: an activatable graphic, an impression, a hyperlink.
